(19) United States
(12) Patent Application Publication
(10) Pub. No.: US 2022/0393879 A1
(43) Pub. Date: Dec. 8, 2022

(54) DECENTRALIZED MECHANISM FOR COLLABORATIVELY GOVERNING MULTI-AGENT TRADE ECOSYSTEM

(71) Applicant: Zhejiang University, Hangzhou (CN)

(72) Inventors: Weihua ZHOU, Hangzhou (CN); Butian HUANG, Hangzhou (CN); Mengnan CHI, Hangzhou (CN); Chenglong LIU, Hangzhou (CN); Mandi XU, Hangzhou (CN); Qinming HE, Hangzhou (CN)

(73) Assignee: Zhejiang University, Hangzhou (CN)

(21) Appl. No.: 17/553,852

(22) Filed: Dec. 17, 2021

(30) Foreign Application Priority Data
May 25, 2021 (CN) 202110570904.8

(51) Int. Cl. H04L 9/32

(52) U.S. Cl. CPC H04L 9/3247; H04L 9/3215; H04L 2209/38

(57) ABSTRACT

A method and a system for managing voting of an alliance chain based on variable strategies are provided. The method specifically includes: 1) classifying channel strategies into an implicit strategy and a strategy based on signature; 2) specifically implementing the variable strategies: initiating, by a user, a proposal request for modifying a strategy; detecting whether a content of the strategy meets a format requirement on the condition that a target strategy is a strategy based on signature; sending a voting invitation or a signature invitation to an organization requiring auditing according to a present channel strategy or a present network strategy; voting or signing by the invited organization; analyzing a result to determine whether the result meets a requirement of the present channel strategy; if so, modifying the present channel strategy to a target channel strategy; otherwise, failing in modification.

### CROSS REFERENCE TO THE RELATED APPLICATIONS

This application is based upon and claims priority to Chinese Patent Application No. 202110570904.8, filed on May 25, 2021, the entire contents of which are incorporated herein by reference.

### TECHNICAL FIELD

The present invention relates to the technical field of blockchains, in particular to a decentralized mechanism for collaboratively governing a multi-agent trade ecosystem.

### BACKGROUND ART

Blockchains are decentralized, which guarantees that all information records are open, transparent and unalterable. Decentralization means that all participants share information, avoids any black-box operation, and greatly reduces the possibility of false fraud. Voting is very crucial to decentralization. Participants vote to decide whether a certain behavior can be accepted by a network.

In an existing Fabric alliance network, channels are all created with the same voting strategy by default. In other words, various voting strategies are difficult to formulate for different channels, which is not conducive to governance of the alliance actually, and lacks a certain degree of flexibility and convenience.

Therefore, in order to solve the problem, different channels are developed with different voting strategies. Variable voting strategies of different channels can flexibly meet the requirements of organizations in the alliance, so as to provide flexibility and convenience for governance of the alliance.

### SUMMARY

Based on the problems proposed in the background art, the present invention provides a method and a system for managing voting of an alliance chain based on variable strategies.

The method for managing voting of an alliance chain based on variable strategies specifically includes:

responding to a proposal request for modifying a strategy initiated by a user;

succeeding in initiating the proposal without detection on the condition that the target strategy is an implicit strategy;

detecting whether a content of the target strategy meets a format requirement on the condition that the target strategy is a strategy based on signature, if so, succeeding in initiating the proposal; otherwise, failing in initiation;

sending a voting invitation or a signature invitation to an organization requiring auditing according to a present strategy, sending a voting invitation according to the present strategy on the condition that the present strategy is an implicit strategy; and sending a signature invitation according to the present strategy on the condition that the present strategy is a strategy based on signature; and

acquiring a voting result or a signature result, and analyzing whether a requirement from a present channel strategy is met on the basis of the voting result or the signature result;

and if so, modifying the present channel strategy.

Further, the implicit strategy includes three types of ALL, ANY and MAJORITY.

Further, the ALL strategy requires affirmative votes of all organizations in the channel, the ANY strategy requires one affirmative vote of the organizations in the channel, and the MAJORITY strategy requires affirmative votes of more than half of the organizations in the channel.

Further, initial strategies of the channels are MAJORITY by default, requiring affirmative votes of more than half of the organizations in the channels.

Further, a content of the strategy is the requirement of the voting result or the information on the signature from a strategy type of the present channel, and for strategy types of different channels, the strategy content is stored on the channel.

Every time the strategy type is modified, acquisition of the present channel strategy is required, and a content of the channel strategy is compared according to information on voting or signature.

The present channel strategy is modified and the content of the present channel strategy stored in a publicchain is updated on the condition that a voting result meets the requirement of the voting result from the present channel strategy or the information on the signature meets the requirement of the information on the signature from the present channel strategy;

if not, modification fails.

The strategy based on the signature may freely specify a voting organization and a voting strategy, and merely requires acquisition of signature of the corresponding voting organization according to the specified voting strategy.

Further, the strategy based on the signature includes one or more of an AND strategy, an OR strategy and an OutOf strategy:

the AND strategy requiring signature of N organizations of all specified organizations numbered N;

the OR strategy requiring signature of at least one organization of all specified organizations numbered N;

and the OutOf strategy requiring affirmative votes of at least M specified organizations and signature of at least M organizations of all specified organizations numbered N, where M≤N.

A combination of any two of the above three strategies and a combination of the three strategies may also be used.

Further, a reference format of the strategy based on the signature is as follows:

(1) AND (“baas1.admin”, “baas2.admin”) specifies organizations baas1 and baas2, and requires joint signature of the two organizations;

(2) OR (“baas1.admin”, “baas2.admin”) specifies organizations baas1 and baas2, and requires signature of at least one of the organizations.

(3) OutOf (2, “baas1.admin”, “baas2.admin”, “baas3.admin”) specifies organizations baas1, baas2 and baas3, and requires signature of at least two of the organizations;

The system for managing voting of an alliance chain based on variable strategies includes a request response module, a format detection module, an invitation sending module, a result acquisition module and a modification completion module;

the request response module being configured to respond to a proposal request for modifying a strategy initiated by a user;

the format detection module not being used in the case of succeeding in initiating the proposal without detection on the condition that the target strategy is an implicit strategy,

and the format detection module being configured to detect whether a content of the target strategy meets a format requirement on the condition that the target strategy is a strategy based on signature, if so, initiating the proposal succeeding; otherwise, initiation failing;

the invitation sending module being configured to send a voting invitation or a signature invitation to an organization requiring auditing according to a present strategy, send a voting invitation according to the present strategy on the condition that the present strategy is an implicit strategy; and send a signature invitation according to the present strategy on the condition that the present strategy is a strategy based on signature;

the result acquisition module being configured to acquire a voting result or a signature result, and analyze whether a requirement from a present channel strategy is met on the basis of the voting result or the signature result; and

the modification completion module being configured to modify the present channel strategy on the condition that the requirement of the present channel strategy is met on the basis of the voting result or the signature result.

As an embodiment, the method also includes: every time the strategy type is modified, requiring acquisition of the present channel strategy, and comparing a content of the channel strategy according to information on voting or signature;

modifying the present channel strategy and updating the content of the present channel strategy stored in a publicchain on the condition that a voting result meets the requirement of the voting result from the present channel strategy or the information on the signature meets the requirement of information on signature from the present channel strategy;

if not, failing in the modification.

A computer readable storage medium, where a computer program is stored in the computer readable storage medium, the computer program may implement, when executed by a processor, the following steps of the method:

responding to a proposal request for modifying a strategy initiated by a user;

succeeding in initiating the proposal without detection on the condition that the target strategy is an implicit strategy;

detecting whether a content of the target strategy meets a format requirement on the condition that the target strategy is a strategy based on signature, if so, succeeding in initiating the proposal; otherwise, failing in initiation;

sending a voting invitation or a signature invitation to an organization requiring auditing according to a present strategy, sending a voting invitation according to the present strategy on the condition that the present strategy is an implicit strategy; and sending a signature invitation according to the present strategy on the condition that the present strategy is a strategy based on signature; and

acquiring a voting result or a signature result, and analyzing whether a requirement from a present channel strategy is met on the basis of the voting result or the signature result;

and if so, modifying the present channel strategy.

An apparatus for managing voting of an alliance chain based on variable strategies includes a memory, a processor a computer program which is stored on the memory and runnable on the processor, where when executing the computer program, the processor implements the following steps:

responding to a proposal request for modifying a strategy initiated by a user;

succeeding in initiating the proposal without detection on the condition that the target strategy is an implicit strategy;

detecting whether a content of the target strategy meets a format requirement on the condition that the target strategy is a strategy based on signature, if so, succeeding in initiating the proposal; otherwise, failing in initiation;

sending a voting invitation or a signature invitation to an organization requiring auditing according to a present strategy, sending a voting invitation according to the present strategy on the condition that the present strategy is an implicit strategy; and sending a signature invitation according to the present strategy on the condition that the present strategy is a strategy based on signature; and

acquiring a voting result or a signature result, and analyzing whether a requirement from a present channel strategy is met on the basis of the voting result or the signature result;

and if so, modifying the present channel strategy.

Compared with the prior art, the present invention uses a variable strategy mechanism, and the strategies in the channel may be flexibly changed. When the channel strategy is required to be changed in the alliance chain, only the organizations in the alliance chain are required to modify the channel strategy spontaneously, instead of specifying new strategies by creating new channels. Variable voting strategies of the channels may flexibly meet the requirements of the organizations in the alliance, so as to provide flexibility and convenience for governance of the alliance chain.

### BRIEFT DESCRIPTION OF THE DRAWINGS

To describe the technical solutions in the embodiments of the present application more clearly, the following briefly describes the accompanying drawings required in descriptions of the embodiments. Apparently, the accompanying drawings in the following descriptions show merely some embodiments of the present application, and a person of ordinary skill in the art may still derive other accompanying drawings from these accompanying drawings without creative efforts.

FIG. 1 is a flowchart of initialization of a voting strategy when an alliance chain is created in a particular embodiment; and

FIG. 2 is a flowchart of modification of a voting strategy in a particular embodiment.

### DETAILED DESCRIPTION OF THE EMBODIMENTS

To make the objectives, technical solutions, and advantages of the embodiments of the present invention clearer, the following will clearly and completely describes the technical solutions of the present invention with reference to the accompanying drawings. Apparently, the described embodiments are some rather than all of the embodiments of the present invention. All other embodiments obtained by a person of ordinary skill in the art based on the embodiments of the present invention without creative efforts shall fall within the protection scope of the present invention.

A description with reference to the terms “an embodiment”, “a particular embodiment”, “an implementation manner” and “for example” means that a particular feature, structure or characteristic described in conjunction with this embodiment or this example is included in at least one embodiment or example of the present application. In this specification, schematic expressions of the above terms do not necessarily refer to the same embodiment or example. Furthermore, the particular features, structures or characteristics described may be combined in any one or more embodiments or examples in a suitable manner. The sequence of steps involved in the embodiments is used to schematically describe implementation of the present application, is not limited and may be appropriately adjusted as needed.

In a particular embodiment, there are two types of variable strategies, namely an implicit strategy and a strategy based on signature:

The implicit strategy includes three types of ALL, ANY and MAJORITY. The ANY strategy requires one affirmative vote of organizations in a channel, and the MAJORITY strategy requires affirmative votes of more than half of the organizations in the channel.

The strategy based on the signature includes one or more of an AND strategy, an OR strategy and an OutOf strategy. A combination of any two of the above three strategies and a combination of the three strategies may also be used.

In a particular embodiment, the strategy based on the signature includes:
(1) AND (“baas1.admin”, “baas2.admin”) specifies organizations baas1 and baas2, and requires joint signature of the two organizations.
(2) OR (“baas1.admin”, “baas2.admin”) specifies organizations baas1 and baas2, and requires signature of at least one of the organizations.
(3) OutOf (2, “baas1.admin”, “baas2.admin”, “baas3.admin”) specifies organizations baas1, baas2 and baas3, and requires signature of at least two of the organizations.
(4) AND (“baas1.admin”,OR (“baas2.admin”,“baas3.admin”)) specifies organizations baas1, baas2 and baas3 and requires signature of baasl and signature of at least one of baas2 and baas3; and
(5) OutOf (1, AND (“baas1.admin”,“baas2.admin”), “baas3 .admin”)) specifies organizations baas1, baas2 and baas3, and requires joint signature of baas1 and baas2 and signature of baas3.
(6) OR (AND (“baas1. admin”, OutOf(1, “baas2. admin”, “baas3 admin”)) , “baas4 .admin”) specifies organizations baas1, baas2, baas3 and baas4,

and requires signature of baasl and signature of at least one of baas2 and baas3, or signature of baas4.

In a particular embodiment, a system for managing voting of an alliance chain based on variable strategies includes a request response module, a format detection module, an invitation sending module, a result acquisition module and a modification completion module.

The request response module is configured to respond to a proposal request for modifying a strategy initiated by a user.

The format detection module is not used in the case of succeeding in initiating the proposal without detection on the condition that the target strategy is an implicit strategy, and the format detection module is configured to detect whether a content of the target strategy meets a format requirement on the condition that the target strategy is a strategy based on signature, if so, initiating the proposal succeeds; otherwise, initiation fails.

The invitation sending module is configured to send a voting invitation or a signature invitation to an organization requiring auditing according to a present strategy, send a voting invitation according to the present strategy on the condition that the present strategy is an implicit strategy; and send a signature invitation according to the present strategy on the condition that the present strategy is a strategy based on signature.

The result acquisition module is configured to acquire a voting result or a signature result, and analyze whether a requirement from a present channel strategy is met on the basis of the voting result or the signature result.

The modification completion module is configured to modify the present channel strategy on the condition that the requirement of the present channel strategy is met on the basis of the voting result or the signature result.

At the beginning of channel creating, Strategy is set at 2, that is, a type of the strategy is 2 (MAJORITY), which requires affirmative votes of more than half of organizations. An initial channel strategy may also be set at other types by modifying a common chain code.

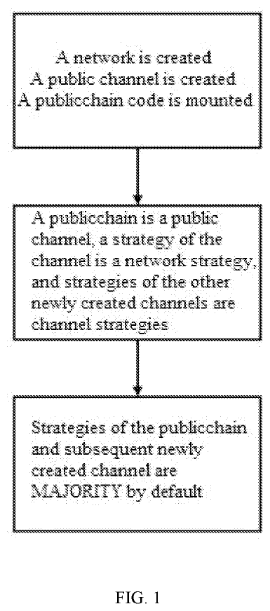

FIG. 1 is a schematic flowchart of initialization of a voting strategy when an alliance chain is created in a particular embodiment. A flow specifically includes:

Step 1, a network is created, a public channel is created and a publicchain code is mounted;

Step 2, for the public channel and a subsequent newly created channel, initial voting strategies are 2 (MAJORITY) by default; and

Step 3, the strategy in the public channel is a network strategy, and strategies in other newly created channels are channel strategies.

Particular implementation is as follows:

| | |
|---|---|
| 1. | “doc”: { |
| 2. | “_id”:“\u0000StrategyDetail\u0000publicchain\u0000”, |
| 3. | “_rev”:“1 -4ed0fc8a3f4a149627f399b76f6fbad8”, |
| 4. | “ChannelName”:“publicchain”, |
| 5. | “CreateTime”:“2021 -05 -07 10:02:58”, |
| 6. | “Detail”:“”, |
| 7. | “Strategy”:2,//the strategy is set at 2 (MAJORITY) from the beginning |
| 8. | “StrategyNature”:0, |
| 9. | “StrategyType”:1, |
| 10. | “CreateTime”:“2021 -05 -07 10:02:58”, |
| 11. | “ ~version”:“\u0000CgMBAQA= ” |
| 12. | } |

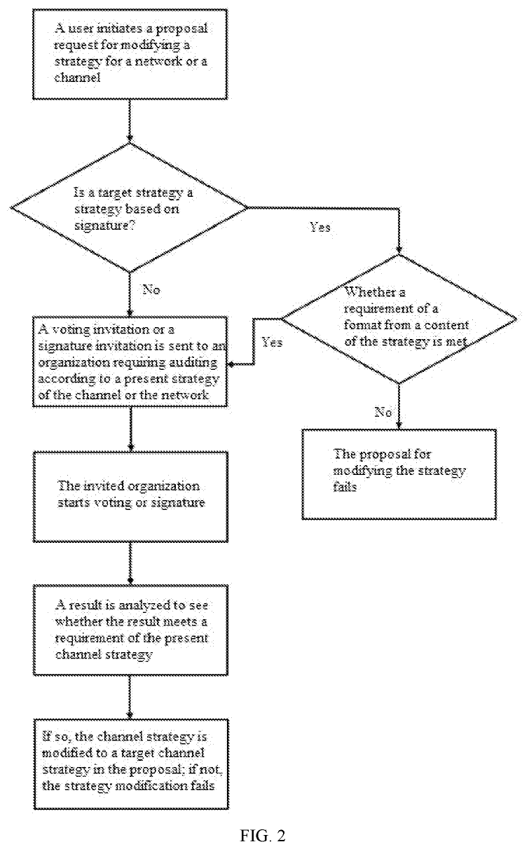

FIG. 2 is a schematic flowchart of modification of a strategy in a particular embodiment. The flow specifically includes:

Step 1: a user initiates a proposal request for modifying a strategy for a network or a channel;

Step 2: whether a content of the strategy meets a format requirement is detected on the condition that a target strategy is a strategy based on signature, if so, initiation succeeds; otherwise, initiation fails;

Step 3: a voting invitation or a signature invitation is sent to an organization requiring auditing according to a present strategy of the channel or the network;

Step 4, the invited organization starts voting or signature;

Step 5, after the voting, a result is analyzed to see whether the result meets a requirement of the present channel strategy; and

Step 6: the present channel strategy is modified to a target channel strategy on the condition that a voting result meets the requirement of the voting result from the present channel strategy or information on the signature meets the requirement of the information on the signature from the present channel strategy; if not, modification fails.

In a particular embodiment, the present channel strategy is 2 (MAJORITY), the target strategy is 1 (ALL), present strategy is the present strategy of the channel publicchain, and strategy is the target strategy.

Particular implementation is as follows:

| | |
|---|---|
| 1. | { |
| 2. | “present_strategy”:“2”,//a type of the present strategy |
| 3. | “proposal_id”:“63816937242624”, |
| 4. | “sign_status”:null, |
| 5. | “status”:“init”, |
| 6. | “strategy”:“1”,//a type of a target strategy |
| 7. | “ ~version”:“\u0000CgMBAwA= ” |
| 8. | } |

A Strategy field of the modified channel strategy of the publicchain has become a target type before, which proves that the channel strategy has been successfully modified.

The Strategy field in a particular embodiment has been modified to 1 (ALL), and the particular implementation is as follows:

| | |
|---|---|
| 1. | “doc”:{ |
| 2. | “-id”\u0000StrategyDetail\u0000publicchain, u0000” |
| 3. | “-rev” “2-664119409459464c008bd8de460f07c2a” |
| 4. | “DhannelName”:”publicchain” |
| 5. | “Create Time”:”2021-05-07 10:02:58”, |
| 6. | “detail”:””, |
| 7. | “Strategy”:1(ALL) |
| 8. | “Strategy”: |
| 9. | “SteategyType”:1, |
| 10. | “UpdateTime”: “2021-05-07 10:15:20”, |
| 11. | “~version”: “\u0000CgMBBQA=” |
| 12. | } |

Other channels modify the voting strategy type in the same way. When the channel is a public channel, a strategy of the public channel is a network strategy, and strategies of other channels are channel strategies, and have the same process principle.

It will become easy for a person of ordinary skill in the art to conceive of other embodiments of the specification after considering the specification and implementing contents disclosed herein. The specification is intended to cover any modification, use or adaptive change of the specification, which follows general principles of the specification and includes common knowledge or conventional technical means in the technical field not disclosed in the specification. The specification and the embodiments are merely regarded as exemplary, with a true scope and spirit of the specification being indicated by the claims.

It should be understood that the specification is not limited to precise structures described above and shown in the accompanying drawings, and various modifications and changes may be made without departing from the scope of the specification. The scope of the specification is merely limited by the appended claims.

What is claimed is:

1. A method for managing voting of an alliance chain based on variable strategies, specifically comprising:
responding to a proposal request for modifying a strategy initiated by a user;
succeeding in initiating a proposal without detection when a target strategy is an implicit strategy;
detecting whether a content of the target strategy meets a format requirement when the target strategy is a strategy based on a signature, wherein
when the content of the target strategy meets the format requirement, succeeding in initiating the proposal; and
when the content of the target strategy does not meet the format requirement, failing in initiation;
sending a voting invitation or a signature invitation to an organization requiring auditing according to a present strategy, wherein
sending the voting invitation according to the present strategy when the present strategy is the implicit strategy; and
sending the signature invitation according to the present strategy when the present strategy is the strategy based on the signature;
acquiring a voting result or a signature result, and analyzing whether a requirement from a present channel strategy is met on a basis of the voting result or the signature result; and
when the requirement from the present channel strategy is met on the basis of the voting result or the signature result, modifying the present channel strategy.

2. The method according to claim 1, wherein
the implicit strategy comprises an ALL strategy, an ANY strategy and an MAJORITY strategy, wherein
the ALL strategy requires affirmative votes of all organizations in a channel,
the ANY strategy requires one affirmative vote of the organizations in the channel, and
the MAJORITY strategy requires affirmative votes of more than half of the organizations in the channel.

3. The method according to claim 2, wherein
from a beginning, a type of strategies of all channels is the MAJORITY strategy by default.

4. The method according to claim 1, further comprising:
requiring acquisition of the present channel strategy, and comparing a content of the present channel strategy according to information on voting or signature every time a strategy type is modified;
modifying the present channel strategy and updating the content of the present channel strategy stored in a publicchain when a voting result meets the requirement of the voting result from the present channel strategy or signature information meets a requirement of the signature information from the present channel strategy;
when the voting result does not meet the requirement of the voting result from the present channel strategy and the signature information does not meet the requirement of the signature information from the present channel strategy, failing in modification.

5. The method according to claim 1, wherein
the strategy based on the signature freely specifies a voting organization and a voting strategy, and a signature of a corresponding voting organization is acquired according to the voting strategy.

6. The method according to claim 5, wherein
the strategy based on the signature comprises at least one selected from the group consisting of an AND strategy, an OR strategy and an OutOf strategy: wherein
the AND strategy requires signature of N organizations of all specified organizations numbered N;
the OR strategy requires signature of at least one organization of all the specified organizations numbered N; and
the OutOf strategy requires affirmative votes of at least M specified organizations and signature of at least M organizations of all the specified organizations numbered N, wherein M<=N.

7. A system for managing voting of an alliance chain based on variable strategies, comprising a request response module, a format detection module, an invitation sending module, a result acquisition module and a modification completion module; wherein
the request response module is configured to respond to a proposal request for modifying a strategy initiated by a user;
the format detection module is not used in a case of succeeding in initiating the proposal without detection when a target strategy is an implicit strategy, and the format detection module is configured to detect whether a content of the target strategy meets a format requirement when the target strategy is a strategy based on a signature, wherein
when the content of the target strategy meets the format requirement, initiating the proposal succeeds; and
when the content of the target strategy does not meet the format requirement, initiation fails;
the invitation sending module is configured to send a voting invitation or a signature invitation to an organization requiring auditing according to a present strategy, wherein
the invitation sending module is configured to send the voting invitation according to the present strategy when the present strategy is the implicit strategy; and
the invitation sending module is configured to send the signature invitation according to the present strategy when the present strategy is the strategy based on the signature;
the result acquisition module is configured to acquire a voting result or a signature result, and analyze whether a requirement from a present channel strategy is met on a basis of the voting result or the signature result; and
the modification completion module is configured to modify the present channel strategy when the requirement of the present channel strategy is met on the basis of the voting result or the signature result.

8. The system according to claim 7, wherein
every time a strategy type is modified, the system requires acquisition of the present channel strategy, and compares a content of the present channel strategy according to information on voting or signature; and
the system modifies the present channel strategy and updates the content of the present channel strategy stored in a publicchain when a voting result meets a requirement of the voting result from the present channel strategy or signature information meets a requirement of the signature information from the present channel strategy;
when the voting result does not meet the requirement of the voting result from the present channel strategy and the signature information does not meet the requirement of the signature information from the present channel strategy, the system fails in modification.

9. A computer readable storage medium, wherein
a computer program is stored in the computer readable storage medium, and
when the computer program is executed by a processor, the computer program implements steps of the method according to claim 1.

10. An apparatus for managing voting of an alliance chain based on variable strategies, comprising: a memory, a processor, and a computer program, wherein
the computer program is stored on the memory and runnable on the processor, and
when the processor executes the computer program, the processor implements steps of the method according to claim 1.

11. The computer readable storage medium according to claim 9, wherein
the implicit strategy comprises an ALL strategy, an ANY strategy and an MAJORITY strategy, wherein
the ALL strategy requires affirmative votes of all organizations in a channel,
the ANY strategy requires one affirmative vote of the organizations in the channel, and
the MAJORITY strategy requires affirmative votes of more than half of the organizations in the channel.

12. The computer readable storage medium according to claim 11, wherein
from a beginning, a type of strategies of all channels is the MAJORITY strategy by default.

13. The computer readable storage medium according to claim 9, the method further comprises:
requiring acquisition of the present channel strategy, and comparing a content of the present channel strategy according to information on voting or signature every time a strategy type is modified;
modifying the present channel strategy and updating the content of the present channel strategy stored in a publicchain when a voting result meets the requirement of the voting result from the present channel strategy or signature information meets a requirement of the signature information from the present channel strategy;
when the voting result does not meet the requirement of the voting result from the present channel strategy and the signature information does not meet the requirement of the signature information from the present channel strategy, failing in modification.

14. The computer readable storage medium according to claim 9, wherein
the strategy based on the signature freely specifies a voting organization and a voting strategy, and a signature of a corresponding voting organization is acquired according to the voting strategy.

15. The method according to claim 14, wherein
the strategy based on the signature comprises at least one selected from the group consisting of an AND strategy, an OR strategy and an OutOf strategy: wherein
the AND strategy requires signature of N organizations of all specified organizations numbered N;
the OR strategy requires signature of at least one organization of all the specified organizations numbered N; and
the OutOf strategy requires affirmative votes of at least M specified organizations and signature of at least M organizations of all the specified organizations numbered N, wherein M<=N.

16. The apparatus according to claim 10, wherein
the implicit strategy comprises an ALL strategy, an ANY strategy and an MAJORITY strategy, wherein
the ALL strategy requires affirmative votes of all organizations in a channel,
the ANY strategy requires one affirmative vote of the organizations in the channel, and
the MAJORITY strategy requires affirmative votes of more than half of the organizations in the channel.

17. The apparatus according to claim 16, wherein
from a beginning, a type of strategies of all channels is the MAJORITY strategy by default.

18. The apparatus according to claim 10, the method further comprises:
requiring acquisition of the present channel strategy, and comparing a content of the present channel strategy according to information on voting or signature every time a strategy type is modified;
modifying the present channel strategy and updating the content of the present channel strategy stored in a publicchain when a voting result meets the requirement of the voting result from the present channel strategy or signature information meets a requirement of the signature information from the present channel strategy;
when the voting result does not meet the requirement of the voting result from the present channel strategy and the signature information does not meet the requirement of the signature information from the present channel strategy, failing in modification.

19. The apparatus according to claim 10, wherein
the strategy based on the signature freely specifies a voting organization and a voting strategy, and a signature of a corresponding voting organization is acquired according to the voting strategy.

20. The apparatus according to claim 19, wherein
the strategy based on the signature comprises at least one selected from the group consisting of an AND strategy, an OR strategy and an OutOf strategy: wherein
the AND strategy requires signature of N organizations of all specified organizations numbered N;
the OR strategy requires signature of at least one organization of all the specified organizations numbered N; and
the OutOf strategy requires affirmative votes of at least M specified organizations and signature of at least M organizations of all the specified organizations numbered N, wherein M<=N.
